(19) United States
(12) Patent Application Publication
(10) Pub. No.: US 2004/0079011 A1
(43) Pub. Date: Apr. 29, 2004

(54) Assembly and methods for exhibiting a rigid display on clothing apparel

(75) Inventors: Kenneth A. Shwartz, Mattapoisett, MA (US); Charles Lord, Mattapoisett, MA (US)

Correspondence Address: FOLEY HOAG, LLP, PATENT GROUP, WORLD TRADE CENTER WEST, 155 SEAPORT BLVD, BOSTON, MA, 02110, US

(73) Assignee: Ahead Headgear, Inc., New Bedford, MA

(21) Appl. No.: 10/282,850

(22) Filed: Oct. 29, 2002

(51) Int. Cl. G09F 3/00; G09F 3/18

(52) U.S. Cl. 40/329; 40/661.05

(57) ABSTRACT

An assembly for exhibiting displays, such as logos, fanciful designs or messages on a clothing apparel. The assembly includes an appliqué having a flexible front layer provided with an opening and a back layer affixed to and extending across the opening of the front layer. The assembly further includes a rigid display securely positioned within the opening of the appliqué. The assembly can be attached to clothing apparel, including a cap and visor by stitching or sewing the appliqué to the clothing apparel. A headgear having an assembly exhibiting a display is also provided.

### TECHNICAL FIELD

The present invention relates generally to accessories for clothing apparel, and more particularly, to an assembly for exhibiting a display on the clothing apparel, such as a cap or a visor.

### BACKGROUND ART

Clothing apparel, including headgears (e.g., visors or caps), have been in use for quite some time to display logos, fanciful designs, special events, messages, or just general advertisement. The exhibition of these displays on the apparel, whether for commercial reasons or for decorative purposes, have mostly been on an area where the fabric is sufficiently soft to permit, for instance, embroidering, sewing, stitching or adhesively affixing the display thereon. In those instances where a display is being exhibited on a visor or a cap, the crown of the cap or the area adjacent the bill where the fabric is sufficiently soft may be used. To a certain extent, displays have also been placed and exhibited on the bill of the visor or cap. Displays have also been provided on other areas of a cap or visor. Such displays, regardless of its location on the headgear, often aim to draw the attention of the viewers.

The displays being exhibited on the clothing apparel, as indicated, are typically an embroidered display or a soft display that is capable of being sewn or adhesively affixed to the garment. However, the use of such display may not always be possible or desired. In certain instances, a solid rigid display, such as a plastic or metallic decal may be desired for a particular effect.

Presently, there are caps that are commercially available having rigid metallic displays exhibited thereon. These metallic displays may be affixed to the cap by, for instance, magnetic attraction or by the use of adhesive. The use of magnetic attraction for affixing a metallic display on the cap may not provide the most secured method for maintaining the display on the cap, especially when the cap is worn by a person participating in an activity which involves excessive movements, including head movements. The affixation of a rigid metallic display on a cap by adhesion, on the other hand, can minimize the possibility of its displacement from the cap. However, typically, the metallic display needs to be bent slightly to conform to the curvature on the crown of the cap. In this manner the contact surfaces between the display and the cap can be maximized. The deformation of the shape of the display, however, can interfere with the visual effect of the design on the display, which interference can be undesirable in certain instances.

Accordingly, it would be desirable to provide a system and method which can securely exhibit a rigid display and which can avoid deforming the rigid display for the purpose of securing the display to the clothing apparel.

### SUMMARY OF THE INVENTION

The present invention, in accordance with one embodiment, provides a display assembly for attachment to a clothing apparel, for example, a cap or visor. The assembly, as provided, can include an appliqué for placement on the clothing apparel. In one embodiment, the appliqué includes a flexible front layer having an opening extending therethrough and a flexible back layer that can be secured to a rear surface of the front layer. Its position against the rear surface of the front layer permits the back layer to extend across the opening of the front layer. The assembly also includes a rigid display (e.g., decal or emblem) securely positioned within the opening and against the back layer of the appliqué. In accordance with an embodiment, the opening can be made to include a size and a shape which complement the size and shape of the rigid display. To that end, the display may have a snug fit within the opening, so that movement of the display therein can be minimized. In addition to its opening, the front layer of the appliqué may be provided with a thickness substantially similar to that of the rigid display to permit a substantially flush transition from the front layer of the appliqué to the display. The assembly may further include an attachment means between the rigid display and the back layer to secure the rigid display against the back layer. The presence of the attachment means can minimize movement of the display and prevent accidental removal of the display from the appliqué.

In accordance with another embodiment of the invention, a method of exhibiting a rigid display on a clothing apparel is provided. The method includes, providing an appliqué having a flexible front layer with an opening sufficiently sized to complementarily receive a display of similar size and shape, and a flexible back layer affixed to a rear surface of the front layer. Thereafter, a rigid display may be secured within the opening. Subsequently, the appliqué may be attached to a clothing apparel. Alternatively, prior to securing the rigid display within the opening, the appliqué maybe attached a clothing apparel. Next, a layer of adhesive may be applied within the opening. Thereafter, the rigid display may be secured within the opening.

The present invention further provides, in another embodiment, a kit for exhibiting a display. The kit includes a flexible front layer and a flexible back layer. The kit also includes means for generating, in the front layer, an opening of a size and shape that complements the size and shape of the rigid display. The kit further includes a rigid display, along with and an adhesive agent for affixing the back layer to the front layer and for securing the display within the opening. In one embodiment of the invention, the kit provides a needle for use in attaching the flexible front and back layers to a clothing apparel.

### BRIEF DESCRIPTION OF THE DRAWINGS

FIG. 1 illustrates a perspective view of an appliqué for use in connection with a rigid display in accordance with one embodiment of the present invention.

FIG. 2 illustrates the appliqué shown in FIG. 1 along with a rigid display thereon.

FIGS. 3A-B illustrate the appliqué and rigid display shown in FIG. 2 exhibited on a cap in accordance with various embodiments of the present invention.

### DETAILED DESCRIPTION OF SPECIFIC EMBODIMENTS

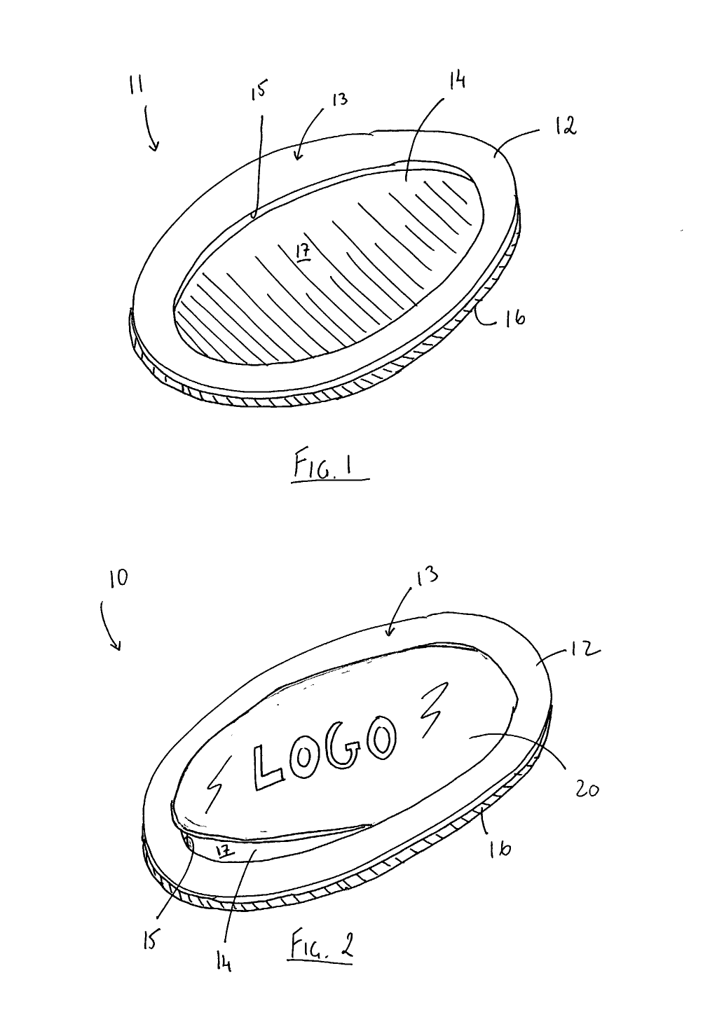

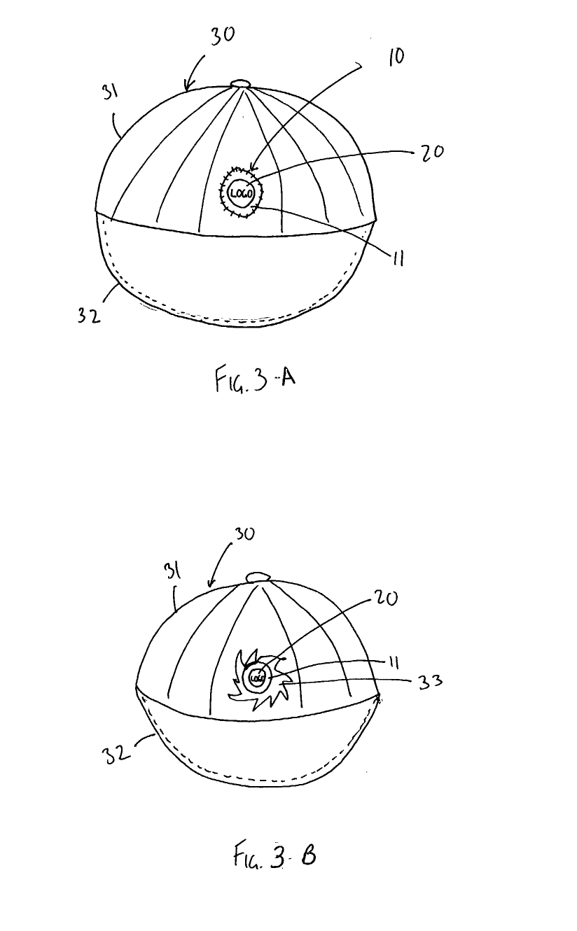

The present invention provides, as illustrated in FIGS. 1-2, an assembly 10 for decoratively displaying logos, fanciful designs, special events, messages, or just general advertisement on clothing apparel, including headgear, such as a cap or a visor.

In FIG. 1. there is shown an appliqué 11 for use in the exhibition of a rigid solid display 20 (FIG. 2) on a clothing apparel. The appliqué 11, in accordance with one embodiment of the present invention, includes a front layer 12 having a top surface 13 and a rear surface (not shown). The front layer 12 further includes an opening 14 extending from the top surface 13 to the rear surface of the front layer 12. The opening 14, in an embodiment, provides an area within which a rigid display 20 may be positioned. It should be appreciated that although shown to be circular in shape, the opening 14 may be of any size or shape which complements the size and shape of the display 20 being used. In an embodiment of the invention, the opening 14 may be provided with a size and shape which permits the display 20 to have a snug fit therein.

Still referring to FIG. 1, the front layer 12 of the appliqué 11 may be provided, with a substantially uniform thickness from one edge to another. Alternatively, the front layer 12 may include a sufficient thickness within the opening 14, while the edges along the periphery of the front layer 12 may be relatively less thick. By providing the front layer 12 with a thickness, at least within the opening 14, a retention wall 15 may be provided circumferentially about the opening 14 to minimize displacement of the display 20 from the opening 14. To further enhance the retention of the display 20 within the opening 14, the retention wall 15, formed by the thickness of the opening 14, may be made so that it is substantially similar in thickness to that of the display 20, thereby permitting the display 20 to sit flush within the opening 14. The presence of a flush transition from the top surface 13 of the front layer 12 to the display 20 positioned within the opening 14 can minimize the tendency to pry or pull the display 20 from the opening 14. It has been observed that permitting the display 20 to elevate or project beyond the opening 14 can often result in the tendency to pry or pull the display 20 from its position within the opening 14.

The appliqué 11, as shown in FIG. 1, further includes a back layer 16 secured to the rear surface of the front layer 12. In one embodiment, the back layer 16 may be affixed to the front layer 12 by an adhesive or bonding agent, such as glue. Of course, other means known in the art may be used to secure the back layer 16 to the front layer 12. The back layer 16 of the appliqué 11, unlike the front layer 12, does not include an opening similar to opening 14. As such, its placement against the rear surface of the front layer 12 allows the back layer 16 to extend across the opening 14. In extending across the opening 14, the back layer 16 is exposed within the opening 14 to provide a surface 17 on which the display 20 may be positioned. In an embodiment of the invention, the back layer 16 may be substantially similar in size to the front layer 12, such that little or no extension of the back layer 16 exists beyond the periphery of the front layer 12.

As the appliqué 11 may be secured to a clothing apparel, for instance, a cap, visor, outerwear or shoe, it is preferable that the front layer 12 and the back layer 16 of the appliqué 11 be made from a material which permits the appliqué 11 to conform to the surface of the clothing apparel onto which the appliqué 11 may be placed. In one embodiment of the invention, the material from which the appliqué 11 may be made can be a soft flexible or pliable material, such as leather, cloth, foam, or other comparable materials used for or in connection with clothing apparel. The use of a soft flexible or pliable material can also permit a stitching, sewing or embroidering needle to penetrate therethrough to secure the appliqué 11 against the clothing apparel.

Looking now at FIG. 2, there is shown a rigid solid display 20 positioned within the opening 14 against the surface 17 of the back layer 16. As indicated above, the rigid display 20, in one embodiment of the invention, is provided with a snug fit within the opening 14, so as to minimize movement of the display 20 within the opening 14. To further minimize movement of the rigid display 20 within the opening 14, a layer of an adhesive or bonding agent may be placed onto the surface 17 between the display 20 and the back layer 16 to securely hold the display 20 in place. Alternatively, other means of attachment known in the art may be used.

The rigid display 20 for use in accordance with an embodiment of the present invention may be made from solid materials such as, metal, wood, plastic or glass, or any other hard solid materials. The use of a rigid solid material can capture an image effect which may not otherwise be attainable when using a typical cloth or embroidered display. Moreover, such solid display materials are durable permitting the display to be exhibited for an extended period of time. An example of a rigid display which may be used in connection with the appliqué 11 of the present invention is a metallic golf ball marker.

Referring now to FIG. 3A, an assembly 10 having the appliqué 11 and the display 20 thereon may be secured to a cap 30 by initially positioning the assembly 10 against a crown portion 31 at an area adjacent a bill 32 of cap 30. Thereafter, the assembly 10 may be sewn or stitched to the cap 30.

Alternatively, rather than sewing or stitching the assembly 10 to the cap 30, a design 33, as illustrated in FIG. 3B, may be embroidered along a periphery of the appliqué 11, over, its edges. In this manner, the assembly 10 may be secured against the cap 30 by the embroidered design 33.

In another embodiment, the appliqué 11 may first be secured against the crown portion 31 of cap 30 by stitching, sewing, or by embroidering a design 33 along a periphery of the appliqué 11, over its edges. Once the appliqué 11 is in place, a layer of adhesive material may be applied to the surface 17 within opening 14. A display 20 may thereafter be positioned within the opening 14 and secured against surface 17.

The present invention also provides a kit for making an assembly 10 to exhibit a display. The kit provides materials for generating an appliqué 11, including a front layer 12, a back layer 16, an adhesive for affixing the back layer 16 to the front layer 12 and for securing a display to the appliqué 11, and a cutting mechanism to generate an opening 14 in the front layer 12 into which a display may be positioned. The kit also includes a set of instructions for generating the opening 14 to match the size and shape of the display to be exhibited and for putting the appliqué 11 together from the materials provided. Should the user not have a particular display for exhibition, the kit can further include a rigid display, such as a decal or emblem for placement within the opening 14 of the appliqué 11. In one embodiment, the kit further includes a stitching and/or sewing needle for securing the assembly 10 to clothing apparel, for instance, a cap or visor.

While the invention has been described in connection with the specific embodiments thereof, it will be understood that it is capable of further modification. For example, although reference has been made to a cap 30, it should be appreciated that a visor, outerwear (e.g., coats, jackets, shirts, pants) and shoes can be easily adapted to include the assembly 10 provided herein. Furthermore, the appliqué 11 may be made to be of any size and/or shape, so long as it is capable of securely retaining a display 20. This application is intended to cover any variations, uses, or adaptations of the invention, including such departures from the present disclosure as come within known or customary practice in the art to which the invention pertains, and as fall within the scope of the appended claims.

What is claimed is:

1. An assembly for exhibiting a rigid display on a clothing apparel, the assembly comprising:
an appliqué for placement on a clothing apparel, the appliqué including
a flexible front layer having an opening extending therethrough, and
a flexible back layer secured to a rear surface of the front layer and extending across the opening; and
a rigid display securely positioned within the opening against the back layer, such that movement of the rigid display within the opening is minimized.

2. An assembly as set forth in claim 1, wherein the opening in the front layer includes a size and a shape which complement the size and shape of the rigid display.

3. An assembly as set forth in claim 1, wherein the front layer has a thickness substantially similar to that of the rigid display to permit a substantially flush transition from the front layer to the display when the display is positioned within the opening.

4. An assembly as set forth in claim 1, wherein the front and back layers of the appliqué are made from a material which permits the appliqué to be stitched or sewn to the clothing apparel.

5. An assembly as set forth in claim 1, wherein the front and back layers are similar in diameter.

6. An assembly as set forth in claim 1 further including an attachment means for securing the rigid display to the back layer within the opening.

7. An assembly as set forth in claim 6, wherein the attachment means includes a layer of at least one of an adhesive and bonding agent positioned between the rigid display and the back layer.

8. An assembly as set forth in claim 1, wherein the rigid display is made from one of the following: metal, wood, plastic and glass.

9. An assembly as set forth in claim 1, wherein the clothing apparel on which the appliqué may be placed includes one of a cap, visor, outerwear and shoes.

10. A method of exhibiting a rigid display on a clothing apparel, the method comprising:
providing an appliqué having (i) a flexible front layer with an opening sufficiently sized and shaped to receive a complementarily sized and shaped rigid display, and (ii) a flexible back layer affixed to a rear surface of the front layer;
securing a rigid display within the opening; and
attaching the appliqué to a clothing apparel.

11. A method as set forth in claim 10, wherein providing an appliqué includes providing the front layer with a thickness substantially similar to that of the rigid display to permit a flush transition from the front layer to the display when the display is positioned within the opening.

12. A method as set forth in claim 10, wherein securing the rigid display includes applying a layer of adhesive within the opening.

13. A method as set forth in claim 10, wherein securing the rigid display includes providing a display made from one of the following: metal, wood, plastic, and glass.

14. A method as set forth in claim 10, wherein attaching the appliqué includes one of stitching and sewing the appliqué to the clothing apparel.

15. A method as set forth in claim 10, wherein attaching the appliqué includes embroidering a pattern along a periphery of the appliqué to secure the appliqué against the clothing apparel.

16. A method of exhibiting a rigid display on a clothing apparel, the method comprising:
providing an appliqué having (i) a flexible front layer with an opening sufficiently sized and shaped to receive a complementarily sized and shaped rigid display, and (ii) a flexible back layer affixed to a rear surface of the front layer;
attaching the appliqué to a clothing apparel;
applying a layer of adhesive within the opening; and
securing a rigid display within the opening.

17. A headgear for exhibiting a display, the headgear comprising:
a crown portion for placement on a head of a person;
a bill portion being attached to the crown portion;
an appliqué for placement on the crown portion at an area adjacent the bill, the appliqué including
a flexible front layer having an opening extending therethrough, and
a flexible back layer secured to a rear surface of the front layer and extending across the opening; and
a rigid display securely positioned within the opening against the back layer, such that movement of the rigid display within the opening is minimized.

18. A kit for exhibiting a rigid display on a clothing apparel, the kit comprising:
a flexible front layer;
a flexible back layer;
means for generating in the front layer an opening of a size and shape that complements the size and shape of the rigid display;
a rigid display for positioning within the opening; and
an adhesive agent for affixing the back layer to the front layer and for securing the display within the opening.

19. A kit as set forth in claim 18 further including a needle for attaching the flexible front and back layers to a clothing apparel.
